(19) United States
(12) Patent Application Publication
(10) Pub. No.: US 2026/0067748 A1
(43) Pub. Date: Mar. 5, 2026

(54) DYNAMIC LOSSY COMPRESSION FOR FEEDBACK MESSAGES

(71) Applicant: QUALCOMM Incorporated, San Diego, CA (US)

(72) Inventors: Mostafa KHOSHNEVISAN, San Diego, CA (US); Kianoush HOSSEINI, San Diego, CA (US); Gokul SRIDHARAN, Sunnyvale, CA (US); Jing SUN, San Diego, CA (US)

(21) Appl. No.: 18/823,521

(22) Filed: Sep. 3, 2024

(51) Int. Cl. H04W 28/06; H04L 5/00; H04W 24/08; H04W 72/231; H04W 72/51

(52) U.S. Cl. CPC H04W 28/06; H04L 5/0053; H04W 24/08; H04W 72/231; H04W 72/51

(57) ABSTRACT

Methods, systems, and devices for wireless communications are described. A user equipment (UE) may receive a control message that indicates one or more parameters for lossy compression of a feedback payload. The one or more parameters may indicate at least a compression ratio between an original feedback payload size and a compressed feedback payload size. The one or more parameters may also indicate a bundle size, a quantity of bundles, a quantity of most likely outcomes to distinguish, a quantity of negative acknowledgments (NACKs) to be distinguished, or a combination thereof. The UE may monitor for one or more downlink transmissions associated with the feedback payload and transmit the feedback payload based on the one or more downlink transmissions. The feedback payload may be compressed from the original feedback payload size to the compressed feedback payload size in accordance with the one or more parameters.

### FIELD OF TECHNOLOGY

The following relates to wireless communications, including dynamic lossy compression for feedback messages.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a control message that indicates one or more parameters for lossy compression of a feedback payload, where the one or more parameters is indicative of at least a compression ratio between an original feedback payload size and a compressed feedback payload size, monitoring for one or more downlink transmissions associated with the feedback payload, and transmitting the feedback payload based on the one or more downlink transmissions, where the feedback payload is compressed from the original feedback payload size to the compressed feedback payload size in accordance with the one or more parameters.

A UE for wireless communications is described. The UE may include one or more memories storing processor executable code, and one or more processors coupled with the one or more memories. The one or more processors may individually or collectively be operable to execute the code to cause the UE to receive a control message that indicates one or more parameters for lossy compression of a feedback payload, where the one or more parameters is indicative of at least a compression ratio between an original feedback payload size and a compressed feedback payload size, monitor for one or more downlink transmissions associated with the feedback payload, and transmit the feedback payload based on the one or more downlink transmissions, where the feedback payload is compressed from the original feedback payload size to the compressed feedback payload size in accordance with the one or more parameters.

Another UE for wireless communications is described. The UE may include means for receiving a control message that indicates one or more parameters for lossy compression of a feedback payload, where the one or more parameters is indicative of at least a compression ratio between an original feedback payload size and a compressed feedback payload size, means for monitoring for one or more downlink transmissions associated with the feedback payload, and means for transmitting the feedback payload based on the one or more downlink transmissions, where the feedback payload is compressed from the original feedback payload size to the compressed feedback payload size in accordance with the one or more parameters.

A non-transitory computer-readable medium storing code for wireless communications is described. The code may include instructions executable by one or more processors to receive a control message that indicates one or more parameters for lossy compression of a feedback payload, where the one or more parameters is indicative of at least a compression ratio between an original feedback payload size and a compressed feedback payload size, monitor for one or more downlink transmissions associated with the feedback payload, and transmit the feedback payload based on the one or more downlink transmissions, where the feedback payload is compressed from the original feedback payload size to the compressed feedback payload size in accordance with the one or more parameters.

In some examples of the method, UEs, and non-transitory computer-readable medium described herein, the one or more parameters may be indicative of a compression scheme from a set of multiple compression schemes and the feedback payload may be compressed based on the indicated compression scheme.

In some examples of the method, UEs, and non-transitory computer-readable medium described herein, the compression scheme may be based on the compression ratio between the original feedback payload size and the compressed feedback payload size.

In some examples of the method, UEs, and non-transitory computer-readable medium described herein, the one or more parameters may be indicative of a quantity of feedback bits to be bundled together into a compressed feedback bit, a quantity of compressed feedback bits, a quantity of bundled feedback outcomes associated with a respective sequence of one or more compressed feedback bits, a quantity of negative acknowledgments (NACKs) per a quantity of feedback bits associated with a respective sequence of one or more compressed feedback bits, or a combination thereof.

In some examples of the method, UEs, and non-transitory computer-readable medium described herein, the control message indicates to apply the one or more parameters to one or more feedback transmissions at least a threshold amount of time after reception of the control message.

In some examples of the method, UEs, and non-transitory computer-readable medium described herein, the control message indicates a component carrier index, a resource, or both associated with the one or more parameters and the feedback payload may be transmitted via the indicated component carrier index, the indicated resource, or both.

In some examples of the method, UEs, and non-transitory computer-readable medium described herein, the control message indicates whether the one or more parameters may be for feedback communicated via a control channel, feedback communicated via a shared channel, or both.

Some examples of the method, UEs, and non-transitory computer-readable medium described herein may further include operations, features, means, or instructions for receiving first control signaling indicating a set of multiple sets of one or more parameters for lossy compression of a feedback payload, where each set of one or more parameters may be associated with a respective set identifier (ID) and receiving second signaling indicating, via a set ID, a set of one or more parameters of the set of multiple sets of one or more parameters, where the feedback payload may be compressed in accordance with the indicated set of one or more parameters.

In some examples of the method, UEs, and non-transitory computer-readable medium described herein, the second signaling schedules the one or more downlink transmissions, includes the control message, or both.

In some examples of the method, UEs, and non-transitory computer-readable medium described herein, the second signaling schedules one or more uplink transmissions and the feedback payload may be multiplexed with the one or more uplink transmissions.

In some examples of the method, UEs, and non-transitory computer-readable medium described herein, the control message may be received via a medium access control-control element (MAC-CE), via a downlink control information (DCI) message, or via a radio resource control (RRC) message.

Some examples of the method, UEs, and non-transitory computer-readable medium described herein may further include operations, features, means, or instructions for receiving a configuration that indicates a DCI format of the control message, the DCI format indicating that the control message includes a field that indicates the one or more parameters for lossy compression of the feedback payload.

Some examples of the method, UEs, and non-transitory computer-readable medium described herein may further include operations, features, means, or instructions for transmitting an assistance information message that includes a set of one or more requested parameters for lossy compression of the feedback payload, where the control message may be based on the assistance information message, and where the feedback payload may be compressed in accordance with the set of one or more requested parameters.

In some examples of the method, UEs, and non-transitory computer-readable medium described herein, the set of one or more requested parameters may be based on a threshold rate at which the UE discards downlink transmissions, a reference signal received power, or both.

Some examples of the method, UEs, and non-transitory computer-readable medium described herein may further include operations, features, means, or instructions for transmitting a capability message that indicates one or more supported compression schemes, one or more supported parameters for lossy compression of the feedback payload, or both, where the control message may be based on the capability message.

A method for wireless communications by a network entity is described. The method may include outputting a control message that indicates one or more parameters for lossy compression of a feedback payload, where the one or more parameters is indicative of at least a compression ratio between an original feedback payload size and a compressed feedback payload size, outputting one or more downlink transmissions associated with the feedback payload, and obtaining the feedback payload based on the one or more downlink transmissions, where the feedback payload is compressed from the original feedback payload size to the compressed feedback payload size in accordance with the one or more parameters.

A network entity for wireless communications is described. The network entity may include one or more memories storing processor executable code, and one or more processors coupled with the one or more memories. The one or more processors may individually or collectively be operable to execute the code to cause the network entity to output a control message that indicates one or more parameters for lossy compression of a feedback payload, where the one or more parameters is indicative of at least a compression ratio between an original feedback payload size and a compressed feedback payload size, output one or more downlink transmissions associated with the feedback payload, and obtain the feedback payload based on the one or more downlink transmissions, where the feedback payload is compressed from the original feedback payload size to the compressed feedback payload size in accordance with the one or more parameters.

Another network entity for wireless communications is described. The network entity may include means for outputting a control message that indicates one or more parameters for lossy compression of a feedback payload, where the one or more parameters is indicative of at least a compression ratio between an original feedback payload size and a compressed feedback payload size, means for outputting one or more downlink transmissions associated with the feedback payload, and means for obtaining the feedback payload based on the one or more downlink transmissions, where the feedback payload is compressed from the original feedback payload size to the compressed feedback payload size in accordance with the one or more parameters.

A non-transitory computer-readable medium storing code for wireless communications is described. The code may include instructions executable by one or more processors to output a control message that indicates one or more parameters for lossy compression of a feedback payload, where the one or more parameters is indicative of at least a compression ratio between an original feedback payload size and a compressed feedback payload size, output one or more downlink transmissions associated with the feedback payload, and obtain the feedback payload based on the one or more downlink transmissions, where the feedback payload is compressed from the original feedback payload size to the compressed feedback payload size in accordance with the one or more parameters.

In some examples of the method, network entities, and non-transitory computer-readable medium described herein, the one or more parameters may be indicative of a compression scheme from a set of multiple compression schemes and the feedback payload may be compressed based on the indicated compression scheme.

In some examples of the method, network entities, and non-transitory computer-readable medium described herein, the compression scheme may be based on the compression ratio between the original feedback payload size and the compressed feedback payload size.

In some examples of the method, network entities, and non-transitory computer-readable medium described herein, the one or more parameters may be indicative of a quantity of feedback bits to be bundled together into a compressed feedback bit, a quantity of compressed feedback bits, a quantity of bundled feedback outcomes associated with a respective sequence of one or more compressed feedback bits, a quantity of NACKs per a quantity of feedback bits associated with a respective sequence of one or more compressed feedback bits, or a combination thereof.

In some examples of the method, network entities, and non-transitory computer-readable medium described herein, the control message indicates a UE to apply the one or more parameters to one or more feedback transmissions at least a threshold amount of time after reception of the control message.

In some examples of the method, network entities, and non-transitory computer-readable medium described herein, the control message indicates a component carrier index, a resource, or both associated with the one or more parameters and the feedback payload may be obtained via the indicated component carrier index, the indicated resource, or both.

In some examples of the method, network entities, and non-transitory computer-readable medium described herein, the control message indicates whether the one or more parameters may be for feedback communicated via a control channel, feedback communicated via a shared channel, or both.

Some examples of the method, network entities, and non-transitory computer-readable medium described herein may further include operations, features, means, or instructions for outputting first control signaling indicating a set of multiple sets of one or more parameters for lossy compression of a feedback payload, where each set of one or more parameters may be associated with a respective set ID and outputting second signaling indicating, via a set ID, a set of one or more parameters of the set of multiple sets of one or more parameters, where the feedback payload may be compressed in accordance with the indicated set of one or more parameters.

In some examples of the method, network entities, and non-transitory computer-readable medium described herein, the second signaling schedules the one or more downlink transmissions, includes the control message, or both.

In some examples of the method, network entities, and non-transitory computer-readable medium described herein, the second signaling schedules one or more uplink transmissions and the feedback payload may be multiplexed with the one or more uplink transmissions.

In some examples of the method, network entities, and non-transitory computer-readable medium described herein, the control message may be output via a MAC-CE, via a DCI message, or via an RRC message.

Some examples of the method, network entities, and non-transitory computer-readable medium described herein may further include operations, features, means, or instructions for outputting a configuration that indicates a DCI format of the control message, the DCI format indicating that the control message includes a field indicating the one or more parameters for lossy compression of the feedback payload.

Some examples of the method, network entities, and non-transitory computer-readable medium described herein may further include operations, features, means, or instructions for obtaining, from a UE, an assistance information message that includes a set of one or more requested parameters for lossy compression of the feedback payload, where the control message may be based on the assistance information message, and where the feedback payload may be compressed in accordance with the set of one or more requested parameters.

In some examples of the method, network entities, and non-transitory computer-readable medium described herein, the set of one or more requested parameters may be based on a threshold rate at which the UE discards downlink transmissions, a reference signal received power, or both.

Some examples of the method, network entities, and non-transitory computer-readable medium described herein may further include operations, features, means, or instructions for obtaining a capability message that indicates one or more supported compression schemes, one or more supported parameters for lossy compression of the feedback payload, or both, where the control message may be based on the capability message.

Some examples of the method, network entities, and non-transitory computer-readable medium described herein may further include operations, features, means, or instructions for obtaining an indication of an uplink channel quality, where the control message may be based on the uplink channel quality.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports dynamic lossy compression for feedback messages in accordance with one or more aspects of the present disclosure.

FIG. 2 shows an example of a wireless communications system that supports dynamic lossy compression for feedback messages in accordance with one or more aspects of the present disclosure.

FIG. 3 shows an example of a process flow that supports dynamic lossy compression for feedback messages in accordance with one or more aspects of the present disclosure.

FIGS. 4 and 5 show block diagrams of devices that support dynamic lossy compression for feedback messages in accordance with one or more aspects of the present disclosure.

FIG. 6 shows a block diagram of a communications manager that supports dynamic lossy compression for feedback messages in accordance with one or more aspects of the present disclosure.

FIG. 7 shows a diagram of a system including a device that supports dynamic lossy compression for feedback messages in accordance with one or more aspects of the present disclosure.

FIGS. 8 and 9 show block diagrams of devices that support dynamic lossy compression for feedback messages in accordance with one or more aspects of the present disclosure.

FIG. 10 shows a block diagram of a communications manager that supports dynamic lossy compression for feedback messages in accordance with one or more aspects of the present disclosure.

FIG. 11 shows a diagram of a system including a device that supports dynamic lossy compression for feedback messages in accordance with one or more aspects of the present disclosure.

FIGS. 12 and 13 show flowcharts illustrating methods that support dynamic lossy compression for feedback messages in accordance with one or more aspects of the present disclosure.

### DETAILED DESCRIPTION

In some wireless communications systems, when uplink signal-to-interference-plus-noise (SINR) is low (e.g., for cell-edge user equipments (UEs) with poor coverage), a UE may compress a feedback payload (e.g., a hybrid automatic repeat request (HARQ) acknowledgment (ACK) or negative acknowledgment (NACK) feedback payload) to improve feedback reception at a network entity. Lossy compression is a type of compression in which the payload is reduced to increase the likelihood that the payload is decoded. However, lossy compression techniques may also increase ACK-to-NACK (A2N) errors, resulting in one or more unnecessary retransmissions. The relative performance of a compression scheme (e.g., a set of compression parameters) may depend on uplink channel conditions. For example, for relatively high uplink SINR, the UE may refrain from compressing the HARQ-ACK feedback, since the uncompressed HARQ-ACK feedback can be successfully decoded by the network entity. In contrast, for relatively low uplink SINR, the UE may apply relatively aggressive lossy compression to reduce the feedback payload at the expense of reduced downlink throughput (e.g., due to A2N errors and associated retransmissions). Dynamic indication of compression parameters for HARQ-ACK may allow devices in a wireless communications system to adapt to channel variations.

In some implementations, a network entity may transmit, to the UE, a control message that indicates one or more compression parameters for lossy compression of a feedback payload. The one or more compression parameters may be indicative of a compression ratio between an original feedback payload size and a compressed feedback payload size. The UE may receive a downlink transmission from the network entity and generate, compress, and transmit a feedback payload associated with the downlink transmission. For example, the UE may compress the feedback payload from the original feedback payload size to the compressed feedback payload size according to the one or more compression parameters. In addition to the compression ratio, the one or more parameters may be indicative of a compression scheme, a bundle size, a quantity of bundles, a quantity of most likely outcomes to distinguish, a quantity of NACKs to distinguish, one or more other parameters, or a combination thereof. The control message may be transmitted via medium access control-control element (MAC-CE), via a downlink control information (DCI) message, via a radio resource control (RRC) message, or a combination thereof. In some examples, the UE may transmit an assistance information message indicating of one or more requested compression parameters, a capability message indicating one or more UE-supported compression parameters for lossy compression of the feedback payload, or both.

Particular aspects of the subject matter described herein may be implemented to realize one or more potential advantages. The described techniques may provide for reduced processing, improved user experience related to reduced processing, reduced power consumption, reduced latency, more efficient utilization of communication resources, improved coordination between devices, and longer battery life. For example, the UE may reduce the feedback payload of a feedback transmission to increase the likelihood that the network entity may successfully decode the feedback payload. Additionally, or alternatively, the UE may use a compression scheme that reduces a rate of A2N errors, thus reducing a quantity of unnecessary retransmissions by the network entity.

Aspects of the disclosure are initially described in the context of wireless communications systems. Aspects of the disclosure are then described in the context of a process flow. Aspects of the disclosure are further illustrated by and described with reference to apparatus diagrams, system diagrams, and flowcharts that relate to dynamic lossy compression for feedback messages.

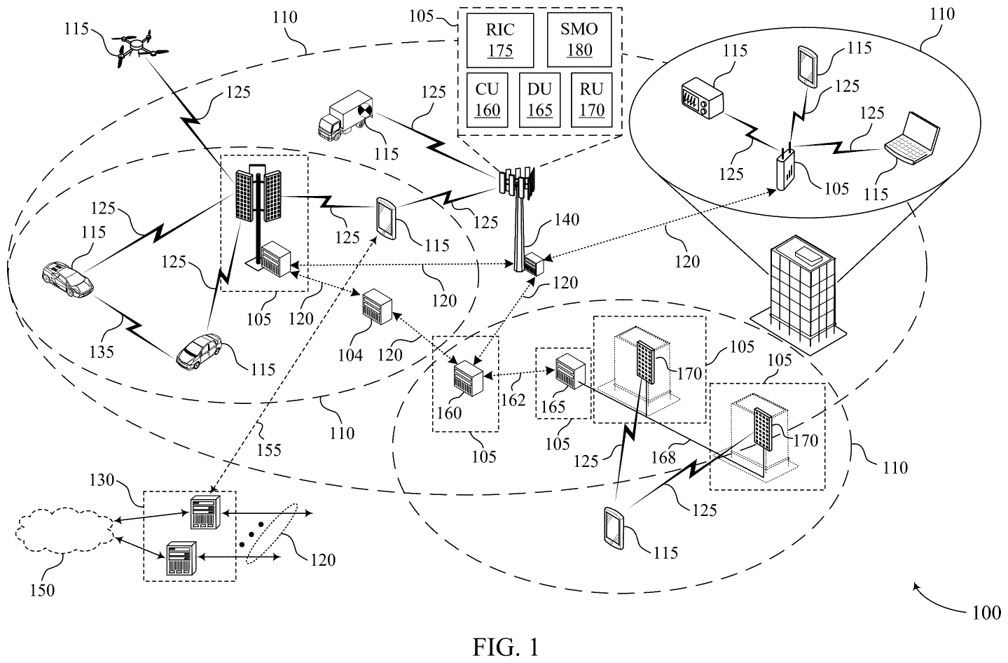

FIG. 1 shows an example of a wireless communications system 100 that supports dynamic lossy compression for feedback messages in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In the wireless communications system 100, when SINR is low (e.g., at the edge of a coverage area 110 with poor coverage), a UE 115 may compress a feedback payload (e.g., HARQ-ACK feedback payload) to improve feedback reception at a network entity 105. Lossy compression is a type of compression in which the payload is reduced to increase the likelihood that the payload is decoded. However, lossy compression techniques may also increase A2N errors, resulting in one or more unnecessary retransmissions. The relative performance of a compression scheme (e.g., a set of compression parameters) may depend on uplink channel conditions. For example, for relatively high uplink SINR, the UE 115 may refrain from compressing the HARQ-ACK feedback, since the uncompressed HARQ-ACK feedback can be successfully decoded by the network entity 105. In contrast, for relatively low uplink SINR, the UE 115 may apply relatively aggressive lossy compression to reduce the feedback payload at the expense of reduced downlink throughput (e.g., due to A2N errors and associated retransmissions). Dynamic indication of compression parameters for HARQ-ACK may allow devices in the wireless communications system 100 to adapt to channel variations.

In some implementations, a network entity 105 may transmit, to a UE 115, a control message that indicates compression parameters for lossy compression of a feedback payload. The compression parameters may indicate a compression ratio between an original feedback payload size and a compressed feedback payload size. The UE 115 may receive a downlink transmission from the network entity 105 and generate, compress, and transmit a feedback payload associated with the downlink transmission. For example, the UE 115 may compress the feedback payload from the original feedback payload size to the compressed feedback payload size according to the one or more parameters. In addition to the compression ratio, the one or more parameters may indicate a compression scheme, a bundle size, a quantity of bundles, a quantity of most likely outcomes to distinguish, a quantity of NACKs to distinguish, one or more other parameters, or a combination thereof. The control message may be transmitted via MAC-CE, via a DCI message, via an RRC message, or a combination thereof. In some examples, the UE 115 may transmit an assistance information message indicating of one or more requested parameters, a capability message indicating one or more UE-supported parameters for lossy compression of the feedback payload, or both.

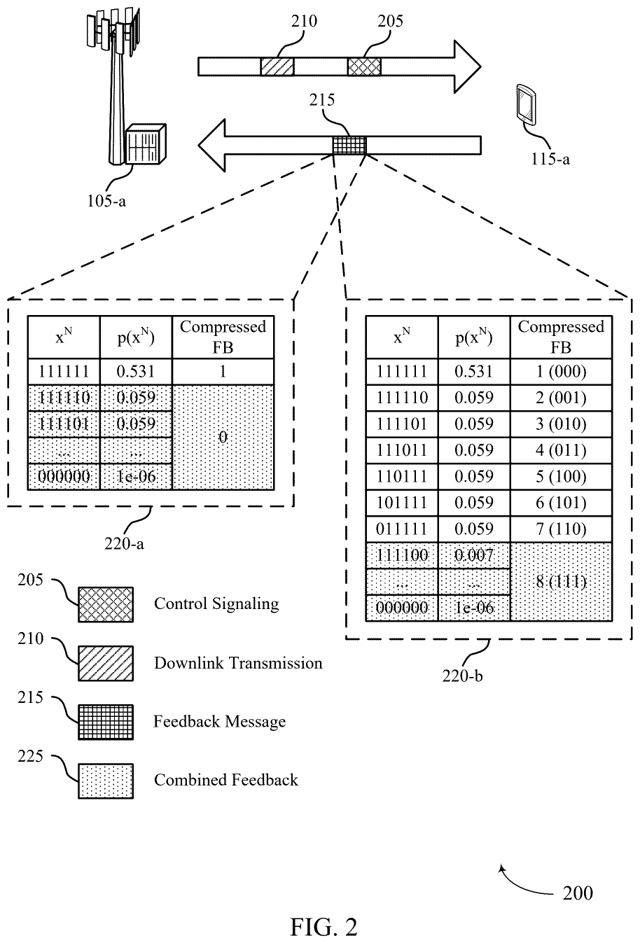

FIG. 2 shows an example of a wireless communications system 200 that supports dynamic lossy compression for feedback messages in accordance with one or more aspects of the present disclosure. In some examples, the wireless communications system 200 may implement aspects of the wireless communications system 100. For example, the wireless communications system 200 includes a UE 115-a and a network entity 105-a, which may be examples of the corresponding devices described with reference to FIG. 1. Additionally, or alternatively, the UE 115-a and the network entity 105-a may each be examples of other types of wireless devices, such as an IAB node or another type of transmitter or receiver. Thus, although aspects of the present disclosure are described with reference to a UE 115 and a network entity 105, it is understood that the described techniques may be performed by a wireless device different from a UE 115 and a network entity 105. As described herein, operations performed by the UE 115-a and the network entity 105-a may be respectively performed by a UE 115, a network entity 105, or another wireless device, and the examples shown should not be construed as limiting.

When uplink channel conditions are poor (e.g., an uplink SINR value for a channel between the UE 115-a and the network entity 105-a is low), the successful decoding rate of a HARQ-ACK feedback payload (e.g., the feedback message 215 associated with the downlink transmission 210) at the network entity 105-a may also be low, resulting in increased retransmissions and inefficiency. To compensate for poor coverage (e.g., resulting from the UE 115-a being at cell-edge), the UE 115-a may compress the feedback payload. For example, using lossy compression techniques, the UE 115-a may reduce a feedback payload size of the feedback message 215 from an original feedback payload size to a compressed feedback payload size.

For example, for a frequency range 1 (FR1) to FR2 deployment in which one or more RUs, DUs, or both are not co-located or coordinated (e.g., the network entity 105-a is disaggregated), FR2 feedback may be sent on FR2. In this case, downlink coverage may be acceptable and the network entity 105-a may configure carrier aggregation (CA) for downlink. The HARQ-ACK feedback payload size in this example may still be relatively large (e.g., 32 bits if 8 downlink component carriers (CCs) in FR2 are configured with a TDD of DDDSU (e.g., downlink, downlink, downlink, special, uplink), such that in each CC, the feedback of four physical downlink shared channels (PDSCHs) are aggregated to be sent on a physical uplink control channel (PUCCH) or a physical uplink shared channel (PUSCH)). However, if the feedback payload cannot go through (e.g., be successfully decoded by the network entity 105-a) on FR2 due to poor uplink coverage, the downlink coverage may also be limited. Lossy compression techniques may be used in this case to reduce the payload of the HARQ-ACK transmission and thereby increase the PUCCH coverage range. In some cases, loss of HARQ-ACK information as a result of lossy compression may impact downlink throughput. That is, even though the compressed HARQ-ACK feedback is decoded, after de-compression of the compressed HARQ-ACK feedback, the network entity 105-a may retransmit a portion of the already decoded downlink transport blocks (TBs) due to lossy compression.

Such an impact on downlink throughput may be due to an A2N error, where the UE 115-a sends an ACK for a given PDSCH or TB HARQ ID, but the network entity 105-a interprets the feedback as a NACK due to lossy compression. In some examples, the lossy compression may be designed such that A2N errors may be introduced but NACK-to-ACK (N2A) errors (e.g., which may be more catastrophic because information is lost and not retransmitted) are not introduced. Hence, there is a trade-off: an increased lossy compression ratio (e.g., more aggressive compression) may be associated with a reduced feedback payload and an increased likelihood for the network entity 105-a to decode the PUCCH, but may also be associated with an increased rate of A2N errors (e.g., unnecessary retransmissions) as a result of lossy compression. Dynamic or adaptive lossy compression for HARQ-ACK may therefore be desirable.

The UE 115-a may compress the feedback payload of the feedback message 215 according to a compression scheme 220 (e.g., a method) that does not permit N2A errors and may only introduce an A2N error. For example, in a first compression scheme 220-a (e.g., bundling), the UE 115-a may bundle a quantity of feedback bits (e.g., k bits) together by performing a logical AND operation on the quantity of feedback bits. That is, a compressed feedback bit may be an ACK (e.g., a binary 1) if each of the bundled quantity of feedback bits is an ACK and may be a NACK (e.g., a binary 0) otherwise (e.g., if any one or more of the bundled quantity of feedback bits is a NACK). The quantity of feedback bits to be bundled together, k, may be referred to as a bundle size. A larger bundle size may be associated with more (e.g., more aggressive) lossy compression resulting in a smaller feedback payload of the feedback message 215 but also an increased probability of A2N errors.

For example, the network entity 105-a may output or transmit, and the UE 115-a may receive, 6 downlink transmissions 210. The UE 115-a may generate a HARQ-ACK feedback bit (e.g., 1 for ACK and 0 for NACK) for each of the 6 downlink transmissions 210. For a bundle size of 6, the UE 115-a may compress the 6 feedback bits into a single compressed feedback bit, as depicted by the first compression scheme 220-a of FIG. 2. That is, the UE 115-a may compress the feedback payload size from an original feedback payload size of 6 bits to a compressed feedback payload size of 1 bit, for a compression ratio of 6. If each of the 6 feedback bits is an ACK (e.g., binary 1), then the compressed feedback bit may indicate an ACK and there are no A2N errors (e.g., no loss due to lossy compression). However, if at least one of the 6 feedback bits is a NACK (e.g., binary 0), then the combined feedback 225 (e.g., the compressed feedback bit) may indicate a NACK. In this case, the network entity 105-a may interpret the combined feedback 225 as a NACK for each of the 6 downlink transmissions 210 (e.g., there may be one or more A2N errors) and may retransmit each of the 6 downlink transmissions 210. If each of the 6 feedback bits has a 0.90 probability of being an ACK, then the probability of the compressed feedback bit being an ACK is (0.90)⁶≈0.5314. Similarly, the probability that a single feedback bit out of the 6 bundled feedback bits is a NACK is 0.059, the probability that all 6 of the bundled feedback bits is a NACK is 1e-06, and the probability of an A2N error is approximately 0.37.

In another example of the first compression scheme 220-a, 6 bits of HARQ-ACK feedback may be bundled into 2 bundles that are each associated with a bundle size of 3. That is, the UE 115-a may compress the feedback payload from an original feedback payload size of 6 bits to a compressed feedback payload size of 2 bits, for a compression ratio of 3. In this case, the compressed feedback may be 2 bits (e.g., a first compressed feedback bit for a first bundle and a second compressed feedback bit for a second bundle). If the compressed feedback indicates 11, there may be no A2N errors (e.g., no loss due to lossy compression). If the compressed feedback indicates 10 or 01 (e.g., the network entity 105-a may interpret that the 3 feedback bits of a single bundle are a NACK), there may be one or more A2N errors for the NACK-ed bundle but no A2N errors for the ACK-ed bundle. If the compressed feedback indicates 00, there may be one or more A2N errors for each of the 2 bundles. Table 1 may indicate the probabilities associated with a bundle from this example of the first compression scheme 220-a. When the PUCCH associated with the compressed feedback of Table 1 is decoded by the network entity 105-a, the overall probability of an A2N error if approximately 0.17.

TABLE 1
A first compression scheme 220-a with bundle size of 3.

| x^{N} | p(x^{N}) | Compressed FB |
|---|---|---|
| 111 | 0.729 | 1 |
| 110 | 0.081 | 0 |
| 101 | 0.081 | |
| . . . | . . . | |
| 000 | 0.001 | |

In a second compression scheme 220-b, the UE 115-a may distinguish a quantity of most likely outcomes (e.g., X outcomes) or may distinguish up to a quantity of NACKs (e.g., m NACKs) via a sequence of one or more compressed feedback bits. The UE 115-a may combine together one or more remaining outcomes (e.g., less likely outcomes with more than m NACKs that are not distinguished) into a single sequence of one or more compressed feedback bits. Thus, the UE 115-a may compress the feedback payload size from an original feedback payload size to a compressed feedback payload size of log₂(X+1), where X is the quantity of most likely outcomes that are distinguished. Given that the probability of an ACK is greater than a probability of a NACK when a target downlink block error rate (BLER) is 10% and assuming independent ACK/NACKs, the compressed feedback may distinguish all possibilities with up to m NACKs. Hence,

$${\sum }_{i = 0}^{m} ( \begin{matrix}m \\ i\end{matrix} )$$

possibilities are distinguished resulting in log₂

$$( {\sum }_{i = 0}^{m} ( \begin{matrix}m \\ i\end{matrix} ) + 1 )$$

bits for the compressed feedback. A smaller value of m may be associated with more lossy compression (e.g., more aggressive lossy compression), and thus reduce the payload size and increase the probability of A2N errors.

For example, as illustrated by the second compression scheme 220-b of FIG. 2, the UE 115-b may compress the feedback associated with 6 downlink transmissions 210 by reporting up to m=1 NACK. Thus, the quantity of most likely outcomes to distinguish may be X=1+6=7. The UE 115-a may compress the feedback payload associated with the 6 downlink transmissions 210 from an original feedback payload size of 6 bits to a compressed feedback payload size of log₂(7+1)=3 bits. As shown in FIG. 2, the X=7 most likely outcomes are distinguished by a sequence of 3 compressed feedback bits, including the single most likely outcome in which each of the 6 feedback bits is an ACK (e.g., 111111, compressed to 000), and including each outcome in which up to m=1 of the 6 feedback bits is a NACK (e.g., 111110, 111101, 111011, 110111, 101111, and 011111, compressed to 001, 010, 011, 100, 101, and 110, respectively). Thus, in this example, the UE 115-a may compress the feedback payload from an original feedback payload size of 6 bits to a compressed feedback payload of 3 bits, for a compression ratio of 2. In some examples, the first compression scheme 220-a may be a more aggressive lossy compression technique than the second compression scheme 220-b. If the UE 115-a indicates the compressed feedback to be any of the X=7 most likely outcomes, there may be no A2N error (e.g., no loss due to lossy compression). If, however, the compressed feedback indicates 111 (e.g., the combined feedback 225, in which 2 or more of the 6 feedback bits was a NACK), the network entity 105-a may assume that each of the 6 feedback bits are NACK and may retransmit each of the 6 downlink transmissions 210 (e.g., producing one or more A2N errors). In this example of the second compression scheme 220-b, the overall probability of an A2N error is approximately 0.07 when the PUCCH carrying the feedback message 215 is decoded by the network entity 105-a.

Since both PUCCH decoding error and HARQ-ACK compression result in downlink throughput loss (e.g., due to A2N errors), selection of a preferred compression scheme (e.g., including one or more compression parameters) may depend on uplink SINR. If the uplink SINR is above a first threshold value (e.g., 4 decibels (dB)), the UE 115-a may not compress the feedback in the feedback message 215, since the network entity 105-a may successfully decode the uncompressed HARQ-ACK feedback. If the uplink SINR is below a second threshold value (e.g., very low uplink SINR, such as less than 0 dB), the UE 115-a may apply relatively aggressive compression to the feedback message 215 (e.g., by using the first compression scheme 220-a with a relatively large bundle size). For moderate uplink SINR (e.g., below the first threshold value and above the second threshold value, such as between 0 dB and 4 dB), the UE 115-a may apply less aggressive lossy compression (e.g., by using the second compression scheme 220-b with a relatively small value of X, or m=1). Thus, dynamic indication of compression parameters for HARQ-ACK may be useful, as uplink SINR may change dynamically due to channel variations (e.g., interference variations). Note that for a cell-edge UE (e.g., the UE 115-a), a long PUCCH format may already be used, so changing the PUCCH resource may not help increase throughput or efficiency. PUCCH repetition may also not be helpful in cases where all downlink slots are scheduled (e.g., there are limited uplink slots, and each uplink slot may carry HARQ-ACK feedback for multiple previous downlink slots).

In some implementations, the network entity 105-a may dynamically indicate one or more parameters (e.g., compression parameters) for lossy compression of a HARQ-ACK payload. For example, the network entity 105-a may output or transmit, and the UE 115-a may receive, control signaling 205 that indicates one or more compression parameters. For example, the one or more compression parameters may indicate a compression scheme (e.g., the first compression scheme 220-a based on bundling or the second compression scheme 220-b based on distinguishing more likely outcomes). In the case of the first compression scheme 220-a, the one or more compression parameters may indicate a bundle size or a quantity of bundles. In the case of the second compression scheme 220-b, the one or more compression parameters may indicate a quantity of most likely outcomes X or a value of m (e.g., indicating that the UE 115-a is to distinguish up to m NACKs). For example, the one or more compression parameters may indicate a bundle size of 6, as depicted by the first compression scheme 220-a of FIG. 2. Additionally, or alternatively, the one or more compression parameters may indicate that X=7 (e.g., distinguish the 7 most likely outcomes) or that m=1 (e.g., distinguish outcomes with up to 1 NACK), as depicted by the second compression scheme 220-b of FIG. 2.

In some examples, the one or more compression parameters may be indicative of a compression ratio, which may be a ratio between an original HARQ-ACK size and a compressed HARQ-ACK size. For example, the compression ratio for the first compression scheme 220-a of FIG. 2 may be 6 (e.g., 6 uncompressed feedback bits are compressed to a single compressed feedback bit). Similarly, the compression ratio for the second compression scheme 220-b of FIG. 2 may be 2 (e.g., 6 uncompressed feedback bits are compressed to 3 compressed feedback bits). In some examples, the one or more compression parameters in the control signaling 205 may indicate the compression ratio, and the UE 115-a may determine the compression scheme 220 based on the indicated compression ratio. For example, an indicated compression ratio of greater than or equal to 2 may imply that the UE 115-a is to use the first compression scheme 220-a, and an indicated compression ratio of less than 2 may indicate that the UE 115-a is to use the second compression scheme 220-b. The UE 115-a may also determine one or more additional compression parameters based on the indicated compression ratio. For example, the UE 115-a may derive a bundle size, a value of X, a value of m, or a combination thereof from the indicated compression ratio.

The dynamic indication of compression parameters in the control signaling 205 may be indicated via a MAC-CE, via a DCI message, or via an RRC message. For example, after a MAC-CE command is applied (e.g., a given time, such as 3 milliseconds, after HARQ-ACK transmission associated with the PDSCH containing the MAC-CE), the UE 115-a may apply the indicated compression parameters to subsequent HARQ-ACK transmissions. That is, the control signaling 205 may indicate to apply one or more compression parameters to one or more feedback messages 215 at least a threshold amount of time (e.g., 3 milliseconds) after reception of the control signaling 205 or after transmission of the feedback in response to decoding the control signaling 205. Additionally, or alternatively, the control signaling 205 (e.g., the MAC-CE) may indicate a component carrier (CC) index, such that the one or more indicated compression parameters apply to one or more HARQ-ACK transmissions (e.g., feedback messages 215) for the indicated CC. Additionally, or alternatively, the control signaling 205 may indicate an uplink resource (e.g., PUCCH resource), such that the one or more indicated compression parameters apply to one or more HARQ-ACK transmissions on the indicated uplink resource. In some examples, the control signaling 205 may indicate a first set of compression parameters for HARQ-ACK compression on PUCCH and a second set of compression parameters for HARQ-ACK compression on PUSCH, where the first set of compression parameters and the second set of compression parameters may be different. In some examples, the control signaling 205 may be a single MAC-CE indicating both the first set of compression parameters and the second set of compression parameters. In some other examples, the control signaling 205 may be at least a first MAC-CE indicating the first set of compression parameters and a second MAC-CE indicating the second set of compression parameters.

In some examples, the control signaling 205 may be a DCI message, and a field in the DCI message may indicate the one or more compression parameters. To reduce DCI overhead, the network entity 105-a may output an RRC message to configure the UE 115-a with multiple sets of compression parameters, where each set of compression parameters is associated with a respective set identifier (ID). The network entity 105-a may subsequently output a DCI message (e.g., the control signaling 205) including a field that indicates a set ID from the multiple set IDs. For example, 2 bits in the DCI message may indicate a set of compression parameters associated with a first set ID out of 4 total set ID options. In some examples, the network entity 105-a may, via an RRC message, separately configure the presence of the set ID field in the DCI message for different DCI formats. For example, the RRC message may indicate that the set ID field is to be present in one or more DCI messages of a first DCI format, and may indicate that the set ID field is to be absent in one or more DCI messages of a second DCI format.

In some cases, the DCI message (e.g., second control signaling 205) may schedule one or more downlink transmissions 210 (e.g., PDSCH) and may include the field to indicate a set ID. This may apply to DCI messages with a certain DCI format that is capable of scheduling downlink transmission (e.g., DCI format 1_0, 1_1, or 1_2). In this case, the indicated set of compression parameters may be based on a last (e.g., most recent) DCI message among multiple DCI messages pointing to a same slot or PUCCH resource for HARQ-ACK transmission. Additionally, or alternatively, the DCI message may schedule one or more uplink transmissions (e.g., PUSCH) and may include the field to indicate a set ID. This may apply to DCI messages with a certain DCI format that is capable of scheduling uplink transmission (e.g., DCI formats 0_0, 0_1, or 0_2). In this case, HARQ-ACK (e.g., the feedback message 215) may be multiplexed on the scheduled PUSCH (e.g., the PUCCH of the feedback message 215 may overlap with the scheduled PUSCH). In some cases, the presence of this field in a DCI message may be separately configured by RRC for one or more different DCI formats.

In some examples, the UE 115-a may indicate, suggest, or request a set of one or more compression parameters or a range of compression parameters related to HARQ-ACK compression. For example, the UE 115-a may transmit, to the network entity 105-a, an assistance message that includes UE assistance information (e.g., UAI), including a set of one or more requested compression parameters. This may allow the UE 115-a to suggest or request compression parameters adaptively (e.g., dynamically) based on information at the UE 115-a. For example, the UE 115-a may observe or measure a PDSCH discard rate, which may be the rate at which the UE 115-a discards PDSCHs (e.g., downlink transmissions 210) that have been decoded before due to A2N errors. The UE 115-a may request or suggest one or more compression parameters (e.g., a compression ratio, a compression scheme 220, a bundle size, a quantity of bundles, X, or m) based on the observed PDSCH discard rate. For example, if the PDSCH discard rate exceeds a first threshold value and if an RSRP value is poor (e.g., below a second threshold value), the UE 115-a may request one or more compression parameters associated with more aggressive lossy compression (e.g., a larger bundle size), since the large A2N error rate may be due to PUCCH decoding failure at the network entity 105-a. Alternatively, if the PDSCH discard rate exceeds the first threshold value and if the RSRP value exceeds the second threshold value (e.g., relatively high RSRP), the UE 115-a may request one or more compression parameters associated with more conservative lossy compression (e.g., a smaller bundle size), since the large A2N error rate may be due to lossy compression. The network entity 105-a may select a set of one or more compression parameters based on the UAI from the UE 115-a and may transmit the control signaling 205 in accordance with the selected compression parameters.

Additionally, or alternatively, the UE 115-a may transmit, to the UE 115-a, UE capability signaling that indicates one or more compression parameters or a range of compression parameters supported by the UE 115-a. The network entity 105-a may select a set of one or more compression parameters based on the capability signaling from the UE 115-a and may transmit the control signaling 205 in accordance with the selected compression parameters.

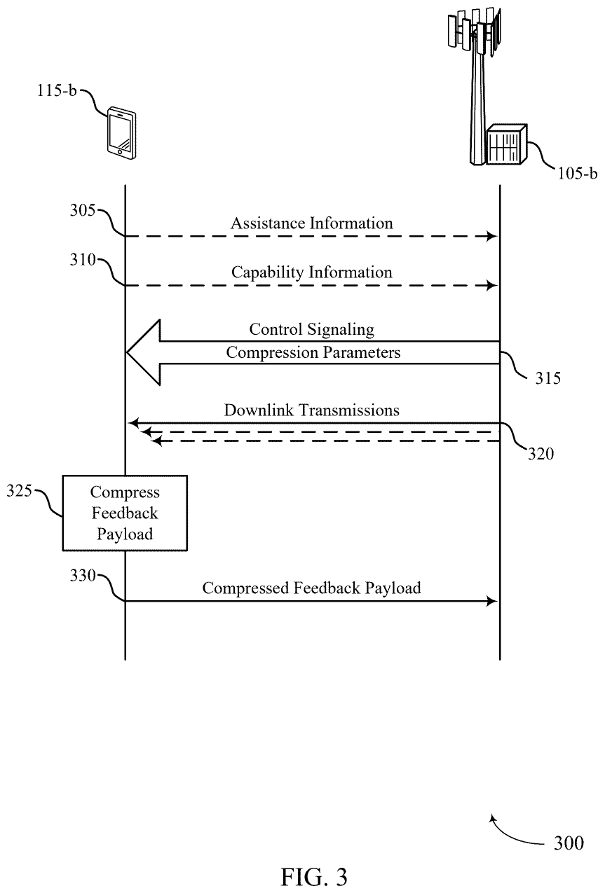

FIG. 3 shows an example of a process flow 300 that supports dynamic lossy compression for feedback messages in accordance with one or more aspects of the present disclosure. In some examples, the process flow 300 may be implemented by, or may implement aspects of, the wireless communications systems 100 and 200. For example, the process flow 300 includes a network entity 105-b and a UE 115-b, which may be examples of the corresponding devices described with reference to FIGS. 1 and 2. Following the process flow 300, the UE 115-b may transmit a compressed feedback payload in accordance with one or more compression parameters for lossy compression. Alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 300, some aspects of some operations may also be performed by one or more other wireless devices.

At 305, the UE 115-b may transmit, and the network entity 105-b may obtain, an assistance information message that includes UE assistance information (UAI) such as a set of one or more requested parameters (e.g., compression parameters) for lossy compression of a feedback payload. For example, the network entity 105-b may select and indicate, via the control signaling at 315, the requested parameters and the UE 115-b may compress, at 325, a feedback payload in accordance with the requested parameters. In some examples, the UE 115-b may adaptively request (e.g., dynamically suggest or indicate) the one or more requested parameters based on information at the UE 115-b, such as a threshold rate at which the UE 115-b discards downlink transmissions, an RSRP value, or both. For example, the UE 115-b may discard downlink transmissions if they have been decoded before (e.g., if the downlink transmissions were sent as part of an A2N error). If a PDSCH discard rate exceeds the threshold rate and the RSRP value is relatively low (e.g., poor), the UE 115-b may request a set of compression parameters associated with relatively aggressive lossy compression (e.g., a relatively large bundle size, since a relatively large A2N error rate may be due to PUCCH decoding failure). In another example, if the PDSCH discard rate exceeds the threshold but the RSRP value is relatively high, the one or more requested parameters may be associated with relatively conservative lossy compression (e.g., a relatively small bundle size, since the large A2N error rate may be due to the lossy compression). In some examples, the UE 115-b may transmit an indication of an uplink channel quality (e.g., the uplink RSRP value) so that the network entity 105-b may select one or more parameters based on the uplink channel quality.

At 310, the UE 115-b may transmit, and the network entity 105-b may obtain, a capability message including capability information related to lossy compression of the feedback payload at 325. For example, the capability message may indicate one or more supported compression schemes, one or more supported compression parameters, or both.

At 315, the UE 115-b may receive, from the network entity 105-b, a control message that indicates one or more parameters (e.g., compression parameters) for lossy compression of a feedback payload. The one or more parameters may indicate at least a compression ratio between an original feedback payload size and a compressed feedback payload size. In some cases, the control message may be based on the assistance information output at 305, the capability information received at 310, or both. In some examples, the one or more parameters may indicate a compression scheme from a set of multiple compression scheme options. For example, a first compression scheme (e.g., the first compression scheme 220-a described in more detail with reference to FIG. 2) of the set of multiple compression scheme options may involve bundling together a quantity of ACK/NACKs. A compressed feedback bit for a first bundle may indicate an ACK (e.g., binary 1) if each of the quantity of ACK/NACKS in the first bundle are ACKs, and the compressed feedback bit for the first bundle may indicate a NACK otherwise (e.g., a value of binary 0 if any of the quantity of ACK/NACKs is a NACK). As another example, a second compression scheme (e.g., the second compression scheme 220-b described in more detail with reference to FIG. 2) in the set of multiple compression scheme options may distinguish a quantity of most likely outcomes. For example, the compressed feedback may have a distinct bit sequence associated with the outcome in which each of a quantity of ACK/NACKs is an ACK, a distinct bit sequence associated with each outcome in which there is a single NACK in the quantity of ACK/NACKs, and a distinct bit sequence associated with the outcome in which there is more than one NACK in the quantity of ACK/NACKs.

In some examples, the compression scheme may be based on the compression ratio between the original feedback payload size and the compressed feedback payload size. That is, in cases where the one or more compression parameters received at 315 indicate the compression ratio but do not explicitly indicate a compression scheme, the UE 115-b may determine the compression scheme based on the indicated compression ratio. For example, the UE 115-b may use the first compression scheme if the compression ratio is at or above a threshold value (e.g., >2) and may use the second compression scheme if the compression ratio is below the threshold value (e.g., <2).

The one or more compression parameters may include one or more additional compression parameters in addition to the compression ratio. In examples where the UE 115-b is to use the first compression scheme (e.g., bundling), the one or more compression parameters may indicate a bundle size (e.g., a quantity of ACK/NACKs or a quantity of feedback bits to be bundled together into a compressed feedback bit), a total quantity of bundles (e.g., a quantity of compressed feedback bits), or both. In examples where the UE 115-b is to use the second compression scheme (e.g., based on most likely outcomes), the one or more compression parameters may indicate a quantity of bundled feedback outcomes associated with a respective sequence of one or more compressed feedback bits (e.g., a quantity of most likely outcomes to distinguish), a quantity NACKs per a quantity of feedback bits associated with a respective sequence of one or more compressed feedback bits (e.g., distinguish up to an indicated quantity of NACKs), or both.

The control message at 315 may be received by the UE 115-b via a MAC-CE, via a DCI message, via an RRC message, or a combination thereof. For example, the network entity 105-b may output the control message via a MAC-CE, and the control message may indicate to apply the one or more compression parameters 3 milliseconds after application of a MAC-CE command. That is, the control message may indicate to apply the one or more compression parameters to one or more feedback transmissions at least a threshold amount of time after reception of the control message. Additionally, or alternatively, the control message may indicate a CC index, a resource (e.g., a PUCCH resource), or both associated with the one or more parameters. For example, the one or more parameters may apply to HARQ-ACK transmissions on the indicated CC index or the indicated PUCCH resource, and the one or more parameters may not apply to HARQ-ACK transmissions on other CC indices or PUCCH resources. Additionally, or alternatively, the control message may indicate whether the one or more compression parameters are for feedback communicated via a control channel (e.g., a PUCCH), feedback communicated via a shared channel (e.g., a PUSCH), or both. In some examples, the control message may indicate different parameters for HARQ-ACK compression on PUCCH and for HARQ-ACK compression on PUSCH. In some cases, a first control message may indicate a first set of one or more compression parameters for feedback communicated via a control channel and a second control message may indicate a second set of one or more compression parameters for feedback communicated via a shared channel. The first set of one or more compression parameters may be the same as or different from the second set of one or more compression parameters.

Transmission of more than one control message may also reduce overhead. For example, the network entity 105-b may output first control signaling (e.g., an RRC message) configuring the UE 115-b with two or more sets of compression parameters with corresponding set IDs. The network entity 105-b may then output second control signaling (e.g., a DCI message) that includes a field to indicate one of the set IDs associated with a set of compression parameters that the UE 115-b is to use to compress an upcoming feedback payload. In some examples, the second signaling (e.g., the DCI message) may schedule the one or more downlink transmissions output at 320, may be or include the control message at 315, or both. That is, a DCI message with a DCI format of 1_0, 1_1, or 1_2 may both 1) schedule the downlink transmissions output at 320 and 2) include a field to indicate a set ID associated with a set of compression parameters. In this case, the indicated set of compression parameters may be based on a most recent DCI message of a set of multiple DCI messages pointing to a same slot or PUCCH resource for HARQ-ACK transmission. Additionally, or alternatively, a DCI message with a DCI format of 0_0, 0_1, or 0_2 may both 1) schedule one or more uplink transmissions (e.g., PUSCH transmissions) and 2) include a field to indicate a set ID associated with a set of compression parameters. This may be the case when the feedback payload is multiplexed with the one or more uplink transmissions (e.g., a PUCCH overlaps with the scheduled PUSCH). The presence of the field in the control message to indicate one of multiple sets of compression parameters may be separately configured by RRC for different DCI formats. For example, the network entity 105-b may output, and the UE 115-b may receive, a configuration (e.g., via an RRC message) that indicates a DCI format of the control message. The DCI format may indicate that the control message includes a field that indicates the one or more compression parameters. For example, the RRC message may indicate a first DCI format indicating an absence of the field in one or more DCI messages with the first DCI format, or the RRC message may indicate a second DCI format indicating a presence of the field in one or more DCI messages with the second DCI format.

At 320, the network entity 105-b may output or transmit, and the UE 115-b may monitor for and receive, one or more downlink transmissions associated with the feedback payload. In some examples, the one or more downlink transmissions may be scheduled by the control signaling at 315.

At 325, the UE 115-b may generate the feedback payload (e.g., with the original payload size) associated with the one or more downlink transmissions received at 320. The UE 115-b may use a lossy compression technique (e.g., in accordance with an indicated compression scheme) to compress the feedback payload from the original payload size to the compressed feedback payload size. The lossy compression may be in accordance with the one or more compression parameters indicated at 315. For example, if the control signaling at 315 indicated that the UE 115-b was to use a first compression scheme (e.g., bundling) and a bundle size of 6, the UE 115-b may compress the feedback payload by bundling 6 ACK/NACKs together.

At 330, the UE 115-b may transmit, and the network entity 105-b may obtain, the feedback payload (e.g., with the compressed feedback payload size) associated with the one or more downlink transmissions received at 320.

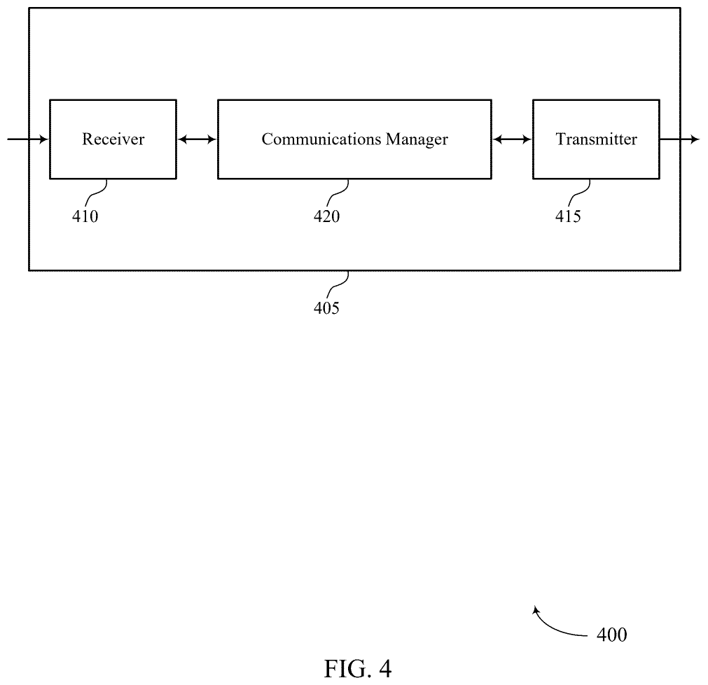

FIG. 4 shows a block diagram 400 of a device 405 that supports dynamic lossy compression for feedback messages in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to dynamic lossy compression for feedback messages). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to dynamic lossy compression for feedback messages). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of dynamic lossy compression for feedback messages as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving a control message that indicates one or more parameters for lossy compression of a feedback payload, where the one or more parameters is indicative of at least a compression ratio between an original feedback payload size and a compressed feedback payload size. The communications manager 420 is capable of, configured to, or operable to support a means for monitoring for one or more downlink transmissions associated with the feedback payload. The communications manager 420 is capable of, configured to, or operable to support a means for transmitting the feedback payload based on the one or more downlink transmissions, where the feedback payload is compressed from the original feedback payload size to the compressed feedback payload size in accordance with the one or more parameters.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced processing, reduced power consumption, and more efficient utilization of communication resources.

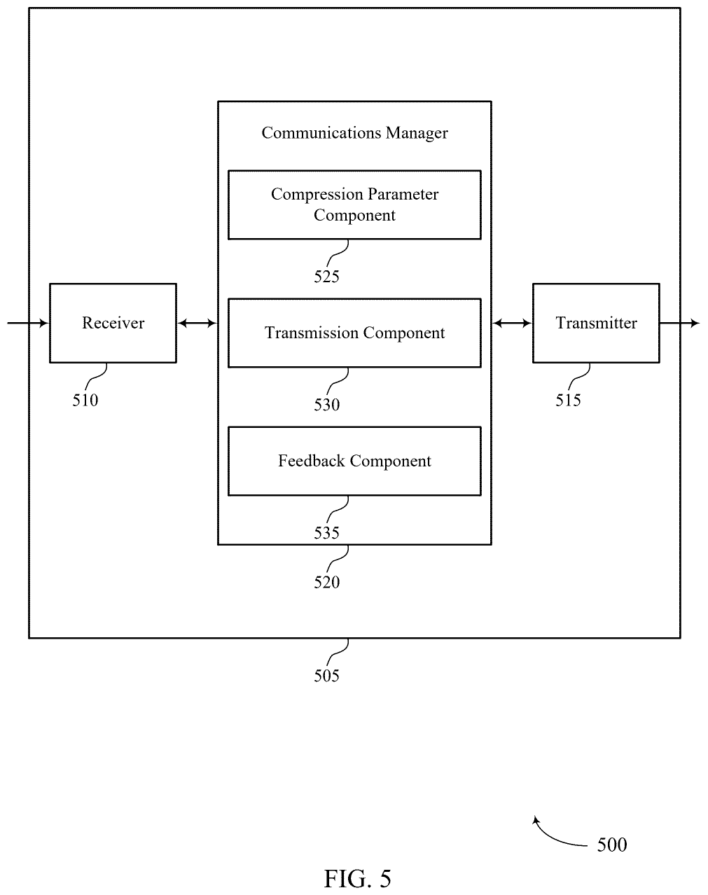

FIG. 5 shows a block diagram 500 of a device 505 that supports dynamic lossy compression for feedback messages in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to dynamic lossy compression for feedback messages). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to dynamic lossy compression for feedback messages). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of dynamic lossy compression for feedback messages as described herein. For example, the communications manager 520 may include a compression parameter component 525, a transmission component 530, a feedback component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The compression parameter component 525 is capable of, configured to, or operable to support a means for receiving a control message that indicates one or more parameters for lossy compression of a feedback payload, where the one or more parameters is indicative of at least a compression ratio between an original feedback payload size and a compressed feedback payload size. The transmission component 530 is capable of, configured to, or operable to support a means for monitoring for one or more downlink transmissions associated with the feedback payload. The feedback component 535 is capable of, configured to, or operable to support a means for transmitting the feedback payload based on the one or more downlink transmissions, where the feedback payload is compressed from the original feedback payload size to the compressed feedback payload size in accordance with the one or more parameters.

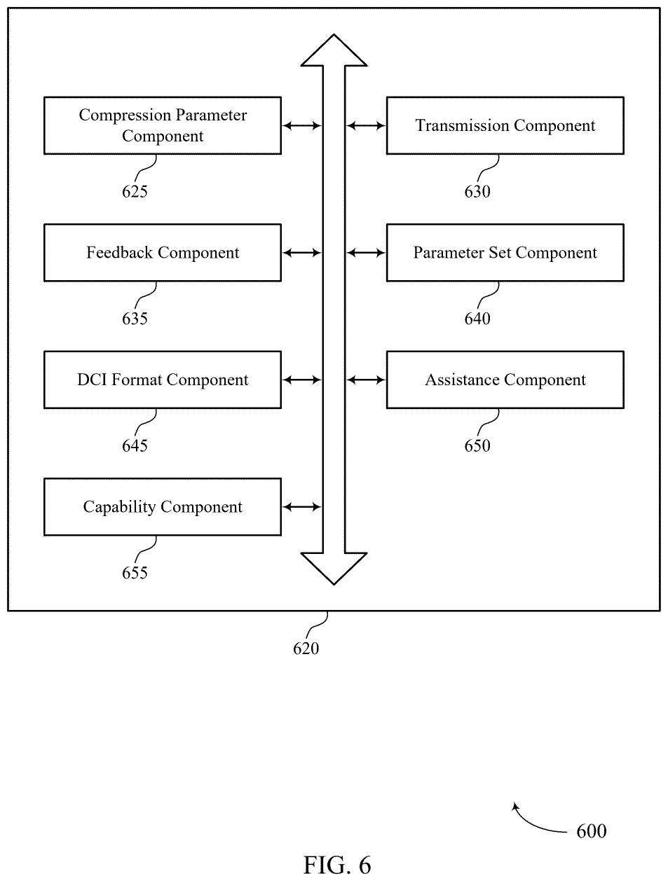

FIG. 6 shows a block diagram 600 of a communications manager 620 that supports dynamic lossy compression for feedback messages in accordance with one or more aspects of the present disclosure. The communications manager 620 may be an example of aspects of a communications manager 420, a communications manager 520, or both, as described herein. The communications manager 620, or various components thereof, may be an example of means for performing various aspects of dynamic lossy compression for feedback messages as described herein. For example, the communications manager 620 may include a compression parameter component 625, a transmission component 630, a feedback component 635, a parameter set component 640, a DCI format component 645, an assistance component 650, a capability component 655, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The compression parameter component 625 is capable of, configured to, or operable to support a means for receiving a control message that indicates one or more parameters for lossy compression of a feedback payload, where the one or more parameters is indicative of at least a compression ratio between an original feedback payload size and a compressed feedback payload size. The transmission component 630 is capable of, configured to, or operable to support a means for monitoring for one or more downlink transmissions associated with the feedback payload. The feedback component 635 is capable of, configured to, or operable to support a means for transmitting the feedback payload based on the one or more downlink transmissions, where the feedback payload is compressed from the original feedback payload size to the compressed feedback payload size in accordance with the one or more parameters.

In some examples, the one or more parameters is indicative of a compression scheme from a set of multiple compression schemes. In some examples, the feedback payload is compressed based on the indicated compression scheme.

In some examples, the compression scheme is based on the compression ratio between the original feedback payload size and the compressed feedback payload size.

In some examples, the one or more parameters is indicative of a quantity of feedback bits to be bundled together into a compressed feedback bit, a quantity of compressed feedback bits, a quantity of bundled feedback outcomes associated with a respective sequence of one or more compressed feedback bits, a quantity of negative acknowledgments (NACKs) per a quantity of feedback bits associated with a respective sequence of one or more compressed feedback bits, or a combination thereof.

In some examples, the control message indicates to apply the one or more parameters to one or more feedback transmissions at least a threshold amount of time after reception of the control message.

In some examples, the control message indicates a component carrier index, a resource, or both associated with the one or more parameters. In some examples, the feedback payload is transmitted via the indicated component carrier index, the indicated resource, or both.

In some examples, the control message indicates whether the one or more parameters are for feedback communicated via a control channel, feedback communicated via a shared channel, or both.

In some examples, the parameter set component 640 is capable of, configured to, or operable to support a means for receiving first control signaling indicating a set of multiple sets of one or more parameters for lossy compression of a feedback payload, where each set of one or more parameters is associated with a respective set ID. In some examples, the parameter set component 640 is capable of, configured to, or operable to support a means for receiving second signaling indicating, via a set ID, a set of one or more parameters of the set of multiple sets of one or more parameters, where the feedback payload is compressed in accordance with the indicated set of one or more parameters.

In some examples, the second signaling schedules the one or more downlink transmissions, includes the control message, or both.

In some examples, the second signaling schedules one or more uplink transmissions. In some examples, the feedback payload is multiplexed with the one or more uplink transmissions.

In some examples, the control message is received via a MAC-CE, via a DCI message, or via an RRC message.

In some examples, the DCI format component 645 is capable of, configured to, or operable to support a means for receiving control signaling that indicates a DCI format of the control message, the DCI format indicating that the control message includes a field that indicates the one or more parameters for lossy compression of the feedback payload.

In some examples, the assistance component 650 is capable of, configured to, or operable to support a means for transmitting an assistance information message that includes a set of one or more requested parameters for lossy compression of the feedback payload, where the control message is based on the assistance information message, and where the feedback payload is compressed in accordance with the set of one or more requested parameters.

In some examples, the set of one or more requested parameters is based on a threshold rate at which the UE discards downlink transmissions, a reference signal received power, or both.

In some examples, the capability component 655 is capable of, configured to, or operable to support a means for transmitting a capability message that indicates one or more supported compression schemes, one or more supported parameters for lossy compression of the feedback payload, or both, where the control message is based on the capability message.

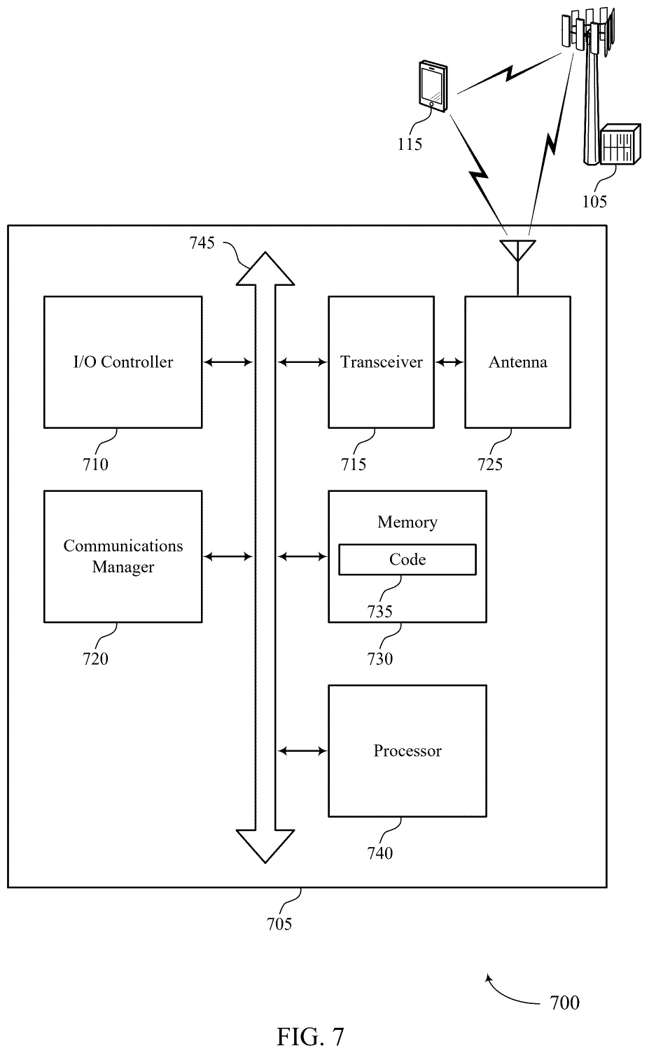

FIG. 7 shows a diagram of a system 700 including a device 705 that supports dynamic lossy compression for feedback messages in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting dynamic lossy compression for feedback messages). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving a control message that indicates one or more parameters for lossy compression of a feedback payload, where the one or more parameters is indicative of at least a compression ratio between an original feedback payload size and a compressed feedback payload size. The communications manager 720 is capable of, configured to, or operable to support a means for monitoring for one or more downlink transmissions associated with the feedback payload. The communications manager 720 is capable of, configured to, or operable to support a means for transmitting the feedback payload based on the one or more downlink transmissions, where the feedback payload is compressed from the original feedback payload size to the compressed feedback payload size in accordance with the one or more parameters.

By including or configuring the communications manager 720 in accordance with examples as described herein, the device 705 may support techniques for reduced latency, improved user experience related to reduced processing, reduced power consumption, more efficient utilization of communication resources, improved coordination between devices, and longer battery life.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of dynamic lossy compression for feedback messages as described herein, or the at least one processor 740 and the at least one memory 730 may be otherwise configured to, individually or collectively, perform or support such operations.

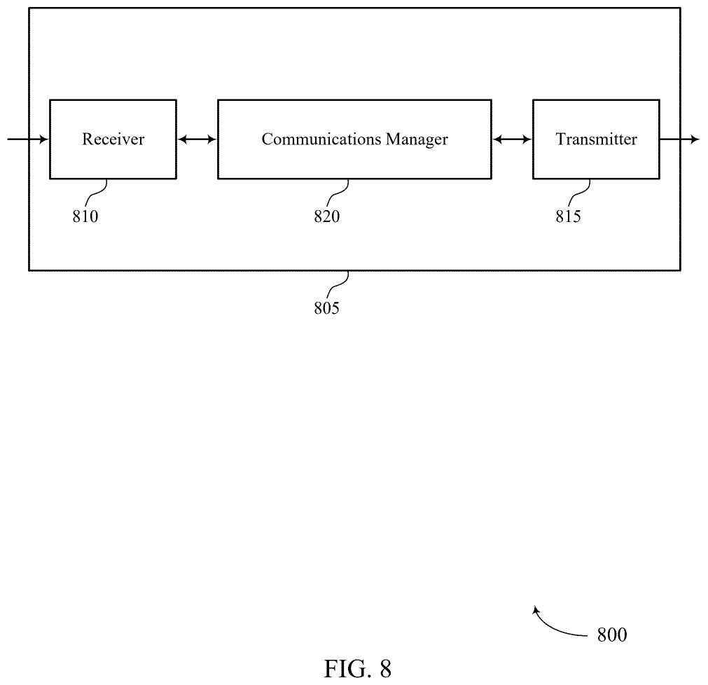

FIG. 8 shows a block diagram 800 of a device 805 that supports dynamic lossy compression for feedback messages in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of dynamic lossy compression for feedback messages as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for outputting a control message that indicates one or more parameters for lossy compression of a feedback payload, where the one or more parameters is indicative of at least a compression ratio between an original feedback payload size and a compressed feedback payload size. The communications manager 820 is capable of, configured to, or operable to support a means for outputting one or more downlink transmissions associated with the feedback payload. The communications manager 820 is capable of, configured to, or operable to support a means for obtaining the feedback payload based on the one or more downlink transmissions, where the feedback payload is compressed from the original feedback payload size to the compressed feedback payload size in accordance with the one or more parameters.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, and more efficient utilization of communication resources

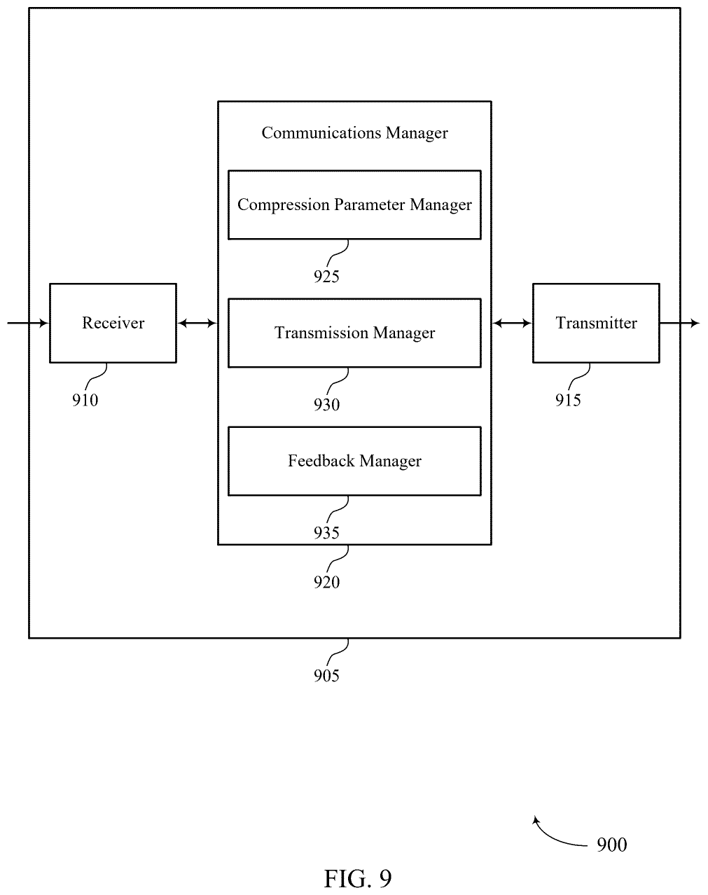

FIG. 9 shows a block diagram 900 of a device 905 that supports dynamic lossy compression for feedback messages in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of dynamic lossy compression for feedback messages as described herein. For example, the communications manager 920 may include a compression parameter manager 925, a transmission manager 930, a feedback manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The compression parameter manager 925 is capable of, configured to, or operable to support a means for outputting a control message that indicates one or more parameters for lossy compression of a feedback payload, where the one or more parameters is indicative of at least a compression ratio between an original feedback payload size and a compressed feedback payload size. The transmission manager 930 is capable of, configured to, or operable to support a means for outputting one or more downlink transmissions associated with the feedback payload. The feedback manager 935 is capable of, configured to, or operable to support a means for obtaining the feedback payload based on the one or more downlink transmissions, where the feedback payload is compressed from the original feedback payload size to the compressed feedback payload size in accordance with the one or more parameters.

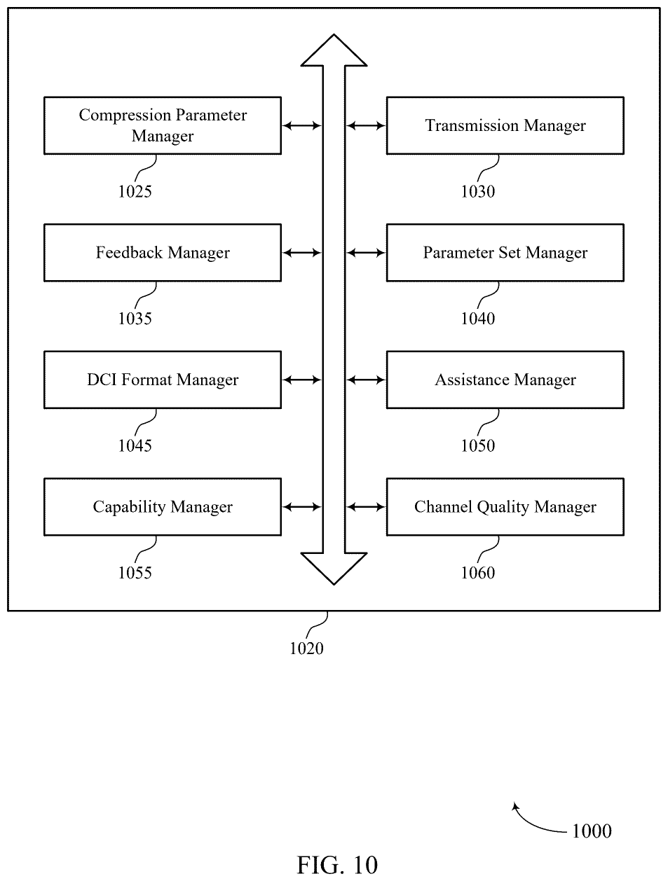

FIG. 10 shows a block diagram 1000 of a communications manager 1020 that supports dynamic lossy compression for feedback messages in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of dynamic lossy compression for feedback messages as described herein. For example, the communications manager 1020 may include a compression parameter manager 1025, a transmission manager 1030, a feedback manager 1035, a parameter set manager 1040, a DCI format manager 1045, an assistance manager 1050, a capability manager 1055, a channel quality manager 1060, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The compression parameter manager 1025 is capable of, configured to, or operable to support a means for outputting a control message that indicates one or more parameters for lossy compression of a feedback payload, where the one or more parameters is indicative of at least a compression ratio between an original feedback payload size and a compressed feedback payload size. The transmission manager 1030 is capable of, configured to, or operable to support a means for outputting one or more downlink transmissions associated with the feedback payload. The feedback manager 1035 is capable of, configured to, or operable to support a means for obtaining the feedback payload based on the one or more downlink transmissions, where the feedback payload is compressed from the original feedback payload size to the compressed feedback payload size in accordance with the one or more parameters.

In some examples, the one or more parameters is indicative of a compression scheme from a set of multiple compression schemes. In some examples, the feedback payload is compressed based on the indicated compression scheme.

In some examples, the compression scheme is based on the compression ratio between the original feedback payload size and the compressed feedback payload size.

In some examples, the one or more parameters is indicative of a quantity of feedback bits to be bundled together into a compressed feedback bit, a quantity of compressed feedback bits, a quantity of bundled feedback outcomes associated with a respective sequence of one or more compressed feedback bits, a quantity of negative acknowledgments (NACKs) per a quantity of feedback bits associated with a respective sequence of one or more compressed feedback bits, or a combination thereof.

In some examples, the control message indicates a UE to apply the one or more parameters to one or more feedback transmissions at least a threshold amount of time after reception of the control message.

In some examples, the control message indicates a component carrier index, a resource, or both associated with the one or more parameters. In some examples, the feedback payload is obtained via the indicated component carrier index, the indicated resource, or both.

In some examples, the control message indicates whether the one or more parameters are for feedback communicated via a control channel, feedback communicated via a shared channel, or both.

In some examples, the parameter set manager 1040 is capable of, configured to, or operable to support a means for outputting first control signaling indicating a set of multiple sets of one or more parameters for lossy compression of a feedback payload, where each set of one or more parameters is associated with a respective set ID. In some examples, the parameter set manager 1040 is capable of, configured to, or operable to support a means for outputting second signaling indicating, via a set ID, a set of one or more parameters of the set of multiple sets of one or more parameters, where the feedback payload is compressed in accordance with the indicated set of one or more parameters.

In some examples, the second signaling schedules the one or more downlink transmissions, includes the control message, or both.

In some examples, the second signaling schedules one or more uplink transmissions. In some examples, the feedback payload is multiplexed with the one or more uplink transmissions.

In some examples, the control message is output via a MAC-CE, via a DCI message, or via an RRC message.

In some examples, the DCI format manager 1045 is capable of, configured to, or operable to support a means for outputting control signaling that indicates a DCI format of the control message, the DCI format indicating that the control message includes a field indicating the one or more parameters for lossy compression of the feedback payload.

In some examples, the assistance manager 1050 is capable of, configured to, or operable to support a means for obtaining, from a UE, an assistance information message that includes a set of one or more requested parameters for lossy compression of the feedback payload, where the control message is based on the assistance information message, and where the feedback payload is compressed in accordance with the set of one or more requested parameters.

In some examples, the set of one or more requested parameters is based on a threshold rate at which the UE discards downlink transmissions, a reference signal received power, or both.

In some examples, the capability manager 1055 is capable of, configured to, or operable to support a means for obtaining a capability message that indicates one or more supported compression schemes, one or more supported parameters for lossy compression of the feedback payload, or both, where the control message is based on the capability message.

In some examples, the channel quality manager 1060 is capable of, configured to, or operable to support a means for obtaining an indication of an uplink channel quality, where the control message is based on the uplink channel quality.

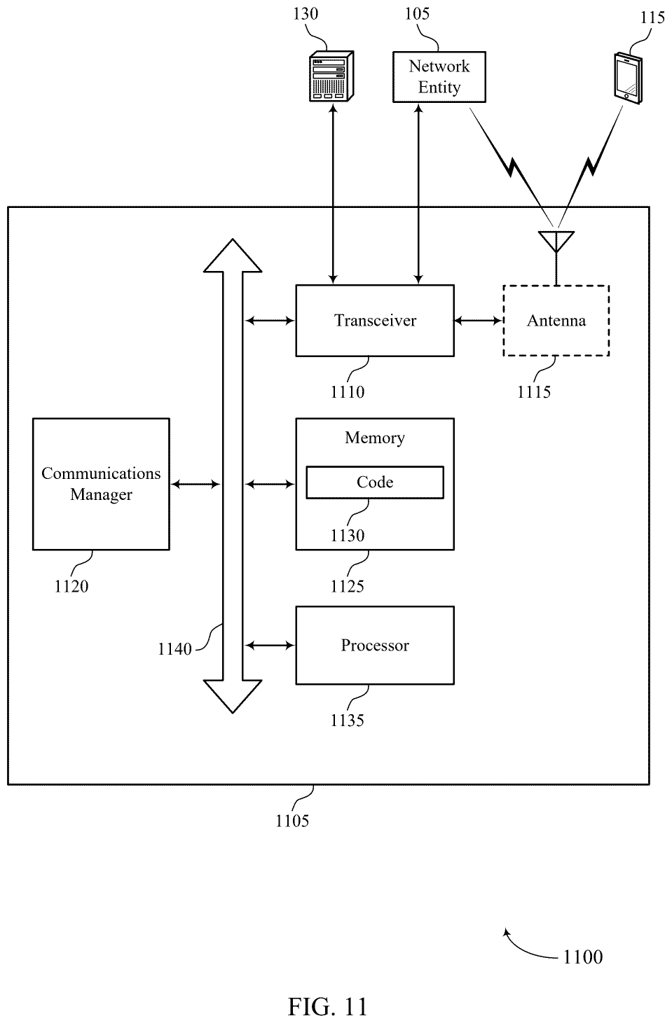

FIG. 11 shows a diagram of a system 1100 including a device 1105 that supports dynamic lossy compression for feedback messages in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting dynamic lossy compression for feedback messages). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for outputting a control message that indicates one or more parameters for lossy compression of a feedback payload, where the one or more parameters is indicative of at least a compression ratio between an original feedback payload size and a compressed feedback payload size. The communications manager 1120 is capable of, configured to, or operable to support a means for outputting one or more downlink transmissions associated with the feedback payload. The communications manager 1120 is capable of, configured to, or operable to support a means for obtaining the feedback payload based on the one or more downlink transmissions, where the feedback payload is compressed from the original feedback payload size to the compressed feedback payload size in accordance with the one or more parameters.

By including or configuring the communications manager 1120 in accordance with examples as described herein, the device 1105 may support techniques for reduced latency, improved user experience related to reduced processing, reduced power consumption, more efficient utilization of communication resources, improved coordination between devices, and longer battery life.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of dynamic lossy compression for feedback messages as described herein, or the at least one processor 1135 and the at least one memory 1125 may be otherwise configured to, individually or collectively, perform or support such operations.

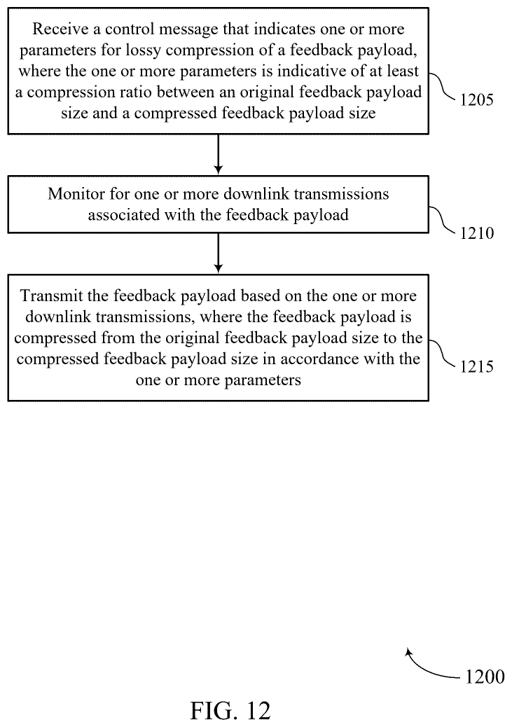

FIG. 12 shows a flowchart illustrating a method 1200 that supports dynamic lossy compression for feedback messages in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving a control message that indicates one or more parameters for lossy compression of a feedback payload, where the one or more parameters is indicative of at least a compression ratio between an original feedback payload size and a compressed feedback payload size. The operations of 1205 may be performed in accordance with examples as disclosed herein. In some examples, aspects of the operations of 1205 may be performed by a compression parameter component 625 as described with reference to FIG. 6.

At 1210, the method may include monitoring for one or more downlink transmissions associated with the feedback payload. The operations of 1210 may be performed in accordance with examples as disclosed herein. In some examples, aspects of the operations of 1210 may be performed by a transmission component 630 as described with reference to FIG. 6.

At 1215, the method may include transmitting the feedback payload based on the one or more downlink transmissions, where the feedback payload is compressed from the original feedback payload size to the compressed feedback payload size in accordance with the one or more parameters. The operations of 1215 may be performed in accordance with examples as disclosed herein. In some examples, aspects of the operations of 1215 may be performed by a feedback component 635 as described with reference to FIG. 6.

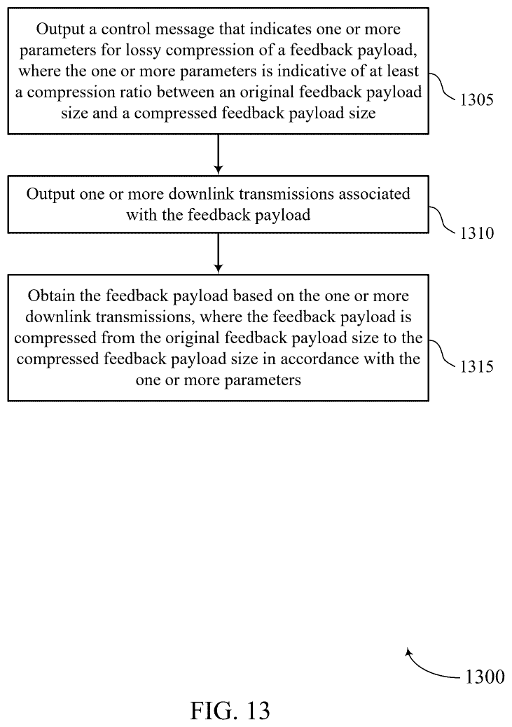

FIG. 13 shows a flowchart illustrating a method 1300 that supports dynamic lossy compression for feedback messages in accordance with one or more aspects of the present disclosure. The operations of the method 1300 may be implemented by a network entity or its components as described herein. For example, the operations of the method 1300 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1305, the method may include outputting a control message that indicates one or more parameters for lossy compression of a feedback payload, where the one or more parameters is indicative of at least a compression ratio between an original feedback payload size and a compressed feedback payload size. The operations of 1305 may be performed in accordance with examples as disclosed herein. In some examples, aspects of the operations of 1305 may be performed by a compression parameter manager 1025 as described with reference to FIG. 10.

At 1310, the method may include outputting one or more downlink transmissions associated with the feedback payload. The operations of 1310 may be performed in accordance with examples as disclosed herein. In some examples, aspects of the operations of 1310 may be performed by a transmission manager 1030 as described with reference to FIG. 10.

At 1315, the method may include obtaining the feedback payload based on the one or more downlink transmissions, where the feedback payload is compressed from the original feedback payload size to the compressed feedback payload size in accordance with the one or more parameters. The operations of 1315 may be performed in accordance with examples as disclosed herein. In some examples, aspects of the operations of 1315 may be performed by a feedback manager 1035 as described with reference to FIG. 10.

The following provides an overview of aspects of the present disclosure:
Aspect 1: A method for wireless communications at a UE, comprising: receiving a control message that indicates one or more parameters for lossy compression of a feedback payload, wherein the one or more parameters is indicative of at least a compression ratio between an original feedback payload size and a compressed feedback payload size; monitoring for one or more downlink transmissions associated with the feedback payload; and transmitting the feedback payload based at least in part on the one or more downlink transmissions, wherein the feedback payload is compressed from the original feedback payload size to the compressed feedback payload size in accordance with the one or more parameters.
Aspect 2: The method of aspect 1, wherein the one or more parameters is indicative of a compression scheme from a plurality of compression schemes, and the feedback payload is compressed based at least in part on the indicated compression scheme.
Aspect 3: The method of aspect 2, wherein the compression scheme is based at least in part on the compression ratio between the original feedback payload size and the compressed feedback payload size.
Aspect 4: The method of any of aspects 1 through 3, wherein the one or more parameters is indicative of a quantity of feedback bits to be bundled together into a compressed feedback bit, a quantity of compressed feedback bits, a quantity of bundled feedback outcomes associated with a respective sequence of one or more compressed feedback bits, a quantity of negative acknowledgments (NACKs) per a quantity of feedback bits associated with a respective sequence of one or more compressed feedback bits, or a combination thereof.
Aspect 5: The method of any of aspects 1 through 4, wherein the control message indicates to apply the one or more parameters to one or more feedback transmissions at least a threshold amount of time after reception of the control message.
Aspect 6: The method of any of aspects 1 through 5, wherein the control message indicates a component carrier index, a resource, or both associated with the one or more parameters, the feedback payload is transmitted via the indicated component carrier index, the indicated resource, or both.
Aspect 7: The method of any of aspects 1 through 6, wherein the control message indicates whether the one or more parameters are for feedback communicated via a control channel, feedback communicated via a shared channel, or both.
Aspect 8: The method of any of aspects 1 through 7, further comprising: receiving first control signaling indicating a plurality of sets of one or more parameters for lossy compression of a feedback payload, wherein each set of one or more parameters is associated with a respective set identifier; and receiving second signaling indicating, via a set identifier, a set of one or more parameters of the plurality of sets of one or more parameters, wherein the feedback payload is compressed in accordance with the indicated set of one or more parameters.
Aspect 9: The method of aspect 8, wherein the second signaling schedules the one or more downlink transmissions, comprises the control message, or both.
Aspect 10: The method of any of aspects 8 through 9, wherein the second signaling schedules one or more uplink transmissions, and the feedback payload is multiplexed with the one or more uplink transmissions.
Aspect 11: The method of any of aspects 1 through 10, wherein the control message is received via a medium access control-control element (MAC-CE), via a DCI message, or via an RRC message.
Aspect 12: The method of any of aspects 1 through 11, further comprising: receiving a configuration that indicates a DCI format of the control message, the DCI format indicating that the control message includes a field that indicates the one or more parameters for lossy compression of the feedback payload.
Aspect 13: The method of any of aspects 1 through 12, further comprising: transmitting an assistance information message that includes a set of one or more requested parameters for lossy compression of the feedback payload, wherein the control message is based at least in part on the assistance information message, and wherein the feedback payload is compressed in accordance with the set of one or more requested parameters.
Aspect 14: The method of aspect 13, wherein the set of one or more requested parameters is based at least in part on a threshold rate at which the UE discards downlink transmissions, a reference signal received power, or both.
Aspect 15: The method of any of aspects 1 through 14, further comprising: transmitting a capability message that indicates one or more supported compression schemes, one or more supported parameters for lossy compression of the feedback payload, or both, wherein the control message is based at least in part on the capability message.
Aspect 16: A method for wireless communications at a network entity, comprising: outputting a control message that indicates one or more parameters for lossy compression of a feedback payload, wherein the one or more parameters is indicative of at least a compression ratio between an original feedback payload size and a compressed feedback payload size; outputting one or more downlink transmissions associated with the feedback payload; and obtaining the feedback payload based at least in part on the one or more downlink transmissions, wherein the feedback payload is compressed from the original feedback payload size to the compressed feedback payload size in accordance with the one or more parameters.
Aspect 17: The method of aspect 16, wherein the one or more parameters is indicative of a compression scheme from a plurality of compression schemes, and the feedback payload is compressed based at least in part on the indicated compression scheme.
Aspect 18: The method of aspect 17, wherein the compression scheme is based at least in part on the compression ratio between the original feedback payload size and the compressed feedback payload size.
Aspect 19: The method of any of aspects 16 through 18, wherein the one or more parameters is indicative of a quantity of feedback bits to be bundled together into a compressed feedback bit, a quantity of compressed feedback bits, a quantity of bundled feedback outcomes associated with a respective sequence of one or more compressed feedback bits, a quantity of negative acknowledgments (NACKs) per a quantity of feedback bits associated with a respective sequence of one or more compressed feedback bits, or a combination thereof.
Aspect 20: The method of any of aspects 16 through 19, wherein the control message indicates a UE to apply the one or more parameters to one or more feedback transmissions at least a threshold amount of time after reception of the control message.
Aspect 21: The method of any of aspects 16 through 20, wherein the control message indicates a component carrier index, a resource, or both associated with the one or more parameters, the feedback payload is obtained via the indicated component carrier index, the indicated resource, or both.
Aspect 22: The method of any of aspects 16 through 21, wherein the control message indicates whether the one or more parameters are for feedback communicated via a control channel, feedback communicated via a shared channel, or both.
Aspect 23: The method of any of aspects 16 through 22, further comprising: outputting first control signaling indicating a plurality of sets of one or more parameters for lossy compression of a feedback payload, wherein each set of one or more parameters is associated with a respective set identifier; and outputting second signaling indicating, via a set identifier, a set of one or more parameters of the plurality of sets of one or more parameters, wherein the feedback payload is compressed in accordance with the indicated set of one or more parameters.
Aspect 24: The method of aspect 23, wherein the second signaling schedules the one or more downlink transmissions, comprises the control message, or both.
Aspect 25: The method of any of aspects 23 through 24, wherein the second signaling schedules one or more uplink transmissions, and the feedback payload is multiplexed with the one or more uplink transmissions.
Aspect 26: The method of any of aspects 16 through 25, wherein the control message is output via a medium access control-control element (MAC-CE), via a DCI message, or via an RRC message.
Aspect 27: The method of any of aspects 16 through 26, further comprising: outputting a configuration that indicates a DCI format of the control message, the DCI format indicating that the control message includes a field indicating the one or more parameters for lossy compression of the feedback payload.
Aspect 28: The method of any of aspects 16 through 27, further comprising: obtaining, from a UE, an assistance information message that includes a set of one or more requested parameters for lossy compression of the feedback payload, wherein the control message is based at least in part on the assistance information message, and wherein the feedback payload is compressed in accordance with the set of one or more requested parameters.
Aspect 29: The method of aspect 28, wherein the set of one or more requested parameters is based at least in part on a threshold rate at which the UE discards downlink transmissions, a reference signal received power, or both.
Aspect 30: The method of any of aspects 16 through 29, further comprising: obtaining a capability message that indicates one or more supported compression schemes, one or more supported parameters for lossy compression of the feedback payload, or both, wherein the control message is based at least in part on the capability message.
Aspect 31: The method of any of aspects 16 through 30, further comprising: obtaining an indication of an uplink channel quality, wherein the control message is based at least in part on the uplink channel quality.
Aspect 32: A UE for wireless communications, comprising one or more memories storing processor-executable code, and one or more processors coupled with the one or more memories and individually or collectively operable to execute the code to cause the UE to perform a method of any of aspects 1 through 15.
Aspect 33: A UE for wireless communications, comprising at least one means for performing a method of any of aspects 1 through 15.
Aspect 34: A non-transitory computer-readable medium storing code for wireless communications, the code comprising instructions executable by one or more processors to perform a method of any of aspects 1 through 15.
Aspect 35: A network entity for wireless communications, comprising one or more memories storing processor-executable code, and one or more processors coupled with the one or more memories and individually or collectively operable to execute the code to cause the network entity to perform a method of any of aspects 16 through 31.
Aspect 36: A network entity for wireless communications, comprising at least one means for performing a method of any of aspects 16 through 31.
Aspect 37: A non-transitory computer-readable medium storing code for wireless communications, the code comprising instructions executable by one or more processors to perform a method of any of aspects 16 through 31.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a control message that indicates one or more parameters for lossy compression of a feedback payload, wherein the one or more parameters is indicative of at least a compression ratio between an original feedback payload size and a compressed feedback payload size;
monitor for one or more downlink transmissions associated with the feedback payload; and
transmit the feedback payload based at least in part on the one or more downlink transmissions, wherein the feedback payload is compressed from the original feedback payload size to the compressed feedback payload size in accordance with the one or more parameters.

2. The UE of claim 1, wherein:
the one or more parameters is indicative of a compression scheme from a plurality of compression schemes, and
the feedback payload is compressed based at least in part on the indicated compression scheme.

3. The UE of claim 2, wherein the compression scheme is based at least in part on the compression ratio between the original feedback payload size and the compressed feedback payload size.

4. The UE of claim 1, wherein the one or more parameters is indicative of a quantity of feedback bits to be bundled together into a compressed feedback bit, a quantity of compressed feedback bits, a quantity of bundled feedback outcomes associated with a respective sequence of one or more compressed feedback bits, a quantity of negative acknowledgments (NACKs) per a quantity of feedback bits associated with a respective sequence of one or more compressed feedback bits, or a combination thereof.

5. The UE of claim 1, wherein the control message indicates to apply the one or more parameters to one or more feedback transmissions at least a threshold amount of time after reception of the control message.

6. The UE of claim 1, wherein the control message indicates a component carrier index, a resource, or both associated with the one or more parameters, and wherein the feedback payload is transmitted via the indicated component carrier index, the indicated resource, or both.

7. The UE of claim 1, wherein the control message indicates whether the one or more parameters are for feedback communicated via a control channel, feedback communicated via a shared channel, or both.

8. The UE of claim 1, wherein the one or more processors are individually or collectively further operable to execute the code to cause the UE to:
receive first control signaling indicating a plurality of sets of one or more parameters for lossy compression of a feedback payload, wherein each set of one or more parameters is associated with a respective set identifier; and
receive second signaling indicating, via a set identifier, a set of one or more parameters of the plurality of sets of one or more parameters, wherein the feedback payload is compressed in accordance with the indicated set of one or more parameters.

9. The UE of claim 8, wherein the second signaling schedules the one or more downlink transmissions, comprises the control message, or both.

10. The UE of claim 8, wherein the second signaling schedules one or more uplink transmissions, and wherein the feedback payload is multiplexed with the one or more uplink transmissions.

11. The UE of claim 1, wherein the control message is received via a medium access control-control element (MAC-CE), via a downlink control information (DCI) message, or via a radio resource control (RRC) message.

12. The UE of claim 1, wherein the one or more processors are individually or collectively further operable to execute the code to cause the UE to:
receive control signaling that indicates a downlink control information (DCI) format of the control message, the DCI format indicating that the control message includes a field that indicates the one or more parameters for lossy compression of the feedback payload.

13. The UE of claim 1, wherein the one or more processors are individually or collectively further operable to execute the code to cause the UE to:
transmit an assistance information message that includes a set of one or more requested parameters for lossy compression of the feedback payload, wherein the control message is based at least in part on the assistance information message, and wherein the feedback payload is compressed in accordance with the set of one or more requested parameters.

14. The UE of claim 13, wherein the set of one or more requested parameters is based at least in part on a threshold rate at which the UE discards downlink transmissions, a reference signal received power, or both.

15. The UE of claim 1, wherein the one or more processors are individually or collectively further operable to execute the code to cause the UE to:
transmit a capability message that indicates one or more supported compression schemes, one or more supported parameters for lossy compression of the feedback payload, or both, wherein the control message is based at least in part on the capability message.

16. A network entity, comprising:
one or more memories storing processor-executable code; and
one or more processors coupled with the one or more memories and individually or collectively operable to execute the code to cause the network entity to:
output a control message that indicates one or more parameters for lossy compression of a feedback payload, wherein the one or more parameters is indicative of at least a compression ratio between an original feedback payload size and a compressed feedback payload size;
output one or more downlink transmissions associated with the feedback payload; and
obtain the feedback payload based at least in part on the one or more downlink transmissions, wherein the feedback payload is compressed from the original feedback payload size to the compressed feedback payload size in accordance with the one or more parameters.

17. The network entity of claim 16, wherein the one or more parameters is indicative of a compression scheme from a plurality of compression schemes, and wherein the feedback payload is compressed based at least in part on the indicated compression scheme.

18. The network entity of claim 17, wherein the compression scheme is based at least in part on the compression ratio between the original feedback payload size and the compressed feedback payload size.

19. The network entity of claim 16, wherein the one or more parameters is indicative of a quantity of feedback bits to be bundled together into a compressed feedback bit, a quantity of compressed feedback bits, a quantity of bundled feedback outcomes associated with a respective sequence of one or more compressed feedback bits, a quantity of negative acknowledgments (NACKs) per a quantity of feedback bits associated with a respective sequence of one or more compressed feedback bits, or a combination thereof.

20. The network entity of claim 16, wherein the control message indicates a user equipment (UE) to apply the one or more parameters to one or more feedback transmissions at least a threshold amount of time after reception of the control message.

21. The network entity of claim 16, wherein the control message indicates a component carrier index, a resource, or both associated with the one or more parameters, and wherein the feedback payload is obtained via the indicated component carrier index, the indicated resource, or both.

22. The network entity of claim 16, wherein the control message indicates whether the one or more parameters are for feedback communicated via a control channel, feedback communicated via a shared channel, or both.

23. The network entity of claim 16, wherein the one or more processors are individually or collectively further operable to execute the code to cause the network entity to:
output first control signaling indicating a plurality of sets of one or more parameters for lossy compression of a feedback payload, wherein each set of one or more parameters is associated with a respective set identifier; and
output second signaling indicating, via a set identifier, a set of one or more parameters of the plurality of sets of one or more parameters, wherein the feedback payload is compressed in accordance with the indicated set of one or more parameters.

24. The network entity of claim 16, wherein the control message is output via a medium access control-control element (MAC-CE), via a downlink control information (DCI) message, or via a radio resource control (RRC) message.

25. The network entity of claim 16, wherein the one or more processors are individually or collectively further operable to execute the code to cause the network entity to:
output control signaling that indicates a downlink control information (DCI) format of the control message, the DCI format indicating that the control message includes a field indicating the one or more parameters for lossy compression of the feedback payload.

26. The network entity of claim 16, wherein the one or more processors are individually or collectively further operable to execute the code to cause the network entity to:
obtain, from a user equipment (UE), an assistance information message that includes a set of one or more requested parameters for lossy compression of the feedback payload, wherein the control message is based at least in part on the assistance information message, and wherein the feedback payload is compressed in accordance with the set of one or more requested parameters.

27. The network entity of claim 16, wherein the one or more processors are individually or collectively further operable to execute the code to cause the network entity to:
obtain a capability message that indicates one or more supported compression schemes, one or more supported parameters for lossy compression of the feedback payload, or both, wherein the control message is based at least in part on the capability message.

28. The network entity of claim 16, wherein the one or more processors are individually or collectively further operable to execute the code to cause the network entity to:
obtain an indication of an uplink channel quality, wherein the control message is based at least in part on the uplink channel quality.

29. A method for wireless communications at a user equipment (UE), comprising:
receiving a control message that indicates one or more parameters for lossy compression of a feedback payload, wherein the one or more parameters is indicative of at least a compression ratio between an original feedback payload size and a compressed feedback payload size;
monitoring for one or more downlink transmissions associated with the feedback payload; and
transmitting the feedback payload based at least in part on the one or more downlink transmissions, wherein the feedback payload is compressed from the original feedback payload size to the compressed feedback payload size in accordance with the one or more parameters.

30. A method for wireless communications at a network entity, comprising:
outputting a control message that indicates one or more parameters for lossy compression of a feedback payload, wherein the one or more parameters is indicative of at least a compression ratio between an original feedback payload size and a compressed feedback payload size;
outputting one or more downlink transmissions associated with the feedback payload; and
obtaining the feedback payload based at least in part on the one or more downlink transmissions, wherein the feedback payload is compressed from the original feedback payload size to the compressed feedback payload size in accordance with the one or more parameters.
